(19) United States
(12) Patent Application Publication
(10) Pub. No.: US 2021/0273780 A1
(43) Pub. Date: Sep. 2, 2021

(54) ENCRYPTED BLOCKCHAIN VOTING SYSTEM

(71) Applicant: Scytale Technologies Ltd, London (GB)

(72) Inventors: Dragos-Liviu Crintea, London (GB); Paul Anthony Cannon, London (GB)

(21) Appl. No.: 17/258,437

(22) PCT Filed: Jul. 8, 2019
(86) PCT No.: PCT/IB2019/055816

§ 371 Date: Jan. 6, 2021

Related U.S. Application Data
(60) Provisional application No. 62/694,761, filed on Jul. 6, 2018.

(51) Int. Cl. H04L 9/00; H04L 29/06; G07C 13/00

(52) U.S. Cl. CPC H04L 9/008; G07C 13/00; H04L 63/0428

(57) ABSTRACT

An improved computer system and method for use with a distributed, preferably immutable, blockchain ledger stores transactional data that can be independently verified while still allowing subsequent updates of the transactional data for a period of time and is advantageously implemented for a blockchain-based voting system to permit updated voting until the voting period closes.

### CROSS-REFERENCE TO RELATED APPLICATIONS

This application claims priority to and the benefit of PCT Application No. PCT/IB2019/055816 filed on Jul. 8, 2019 and entitled Encrypted Blockchain Voting System, which is commonly assigned and the contents of which are expressly incorporated herein by reference. This application also claims priority to and the benefit of U.S. provisional application Ser. No. 62/694,761 filed on Jul. 6, 2018 and entitled An Improved Computer System and Method.

### BACKGROUND

The present invention relates to an improved computer system and method for use with a distributed ledger, preferably a blockchain network with an immutable ledger. Specifically, the improvement relates to the storing of transactional data on an immutable ledger while allowing changes to the transaction. It is advantageously implemented for a blockchain-based voting system to permit updated voting until a voting period closes.

Distributed ledger technology is rapidly becoming a preferred way of storing transactions in an immutable way. In a blockchain distributed ledger, the data is stored in a series of blocks, linked together by mathematical hash functions, so that trying to change a previous transaction in one block will require re-computation of all the subsequent block hashes until the end of the chain—a task that is virtually impossible.

In a typical blockchain implementation employing a proof of work consensus algorithm such as in the bitcoin blockchain, a nonce is determined for a given level of difficulty for a valid hash of a block. Blockchains have been used in a decentralized manner to transact business over untrusted networks and with untrusted peers. Examples of permissionless blockchains are Bitcoin and Ethereum. Permissioned blockchains include Ripple, Stellar, Hyperledger Fabric, Ethereum private blockchain, Quorum, and Corda.

FIG. 1 is a flow chart of proxy voting by individuals in the prior art, in particular, a

method of starting an AGM.

The listed entity announces the AGM to the registrar and to the named members at least one month before the AGM is to be held. The registrar is employed by the listed entity. In the UK, the vast majority of listed entities are with one of three registrars, namely: Equiniti, Computershare and Capita.

The registrar will disseminate the AGM information directly to voting agents and the named members of the listed entity (each a “Named Member”). Where the holder of the underlying security is a custodian bank, the Named Member will be the nominee of the custodian account: i.e., the stockbroker. In such circumstances, the stockbroker will not automatically forward the information on to their client, the first level investor.

Prior to any votes being cast, the custodian of the underlying security will confirm how many shares are held to the Named Member of the listed entity either directly (CREST) or via a voting agent. Where the stockbroker is the Named Member, on request the first level investor may be granted voting rights and rights to information pertaining to the underlying asset. Requests are rare but usually granted by the stockbroker. In such a case, the stockbroker will be responsible for confirming the holding information about the individual investor. Typically, neither the custodian bank nor the registrar have sight of who the first level investor is.

Voters can send their voting information to the chairperson of the AGM via both the voting agent or CREST and the registrar (e.g., the AGM voting report). Alternatively, they can attend the AGM and vote in person (not shown).

The registrar will need to ensure that the voting information they receive is consistent with the register of Named Members. In particular, they ensure that there is not overreach where the votes cast exceed the voting rights held by each voting party. Some first level investors may have obtained pass back rights from the stockbroker to attend the meeting where they will cast their vote. Others may be casting their vote by proxy via their stockbroker. Where the first level investor is totally disengaged, the stockbroker may be determining the voting preferences. In most instances, assets are pooled at the custodian bank level so the holding information for first level investors has to be calculated from information about the investors' share of the pool and also the total holding of the pool. All of this typically occurs in an environment where assets could be being traded around the time of voting. The verification process is done to tight timelines, and where it is not practical to verify the holding information against the register, votes are discarded.

Votes cast in advance are verified and collated by the registrar and are submitted to the chairperson via the AGM voting report. These votes are displayed during the meeting and votes cast at the time may be cast via a show of hands and the chair person oversees this and is responsible for recording the outcome. Where the will of the shareholders is overwhelmingly for or against a motion (as demonstrated by a show of hands) there might not be any poll of total votes cast, only the record of votes cast by proxy. Individual investors may have submitted a paper proxy form or voted on-line and it is common to not receive feedback about whether their vote was counted. There is also a very binary measure of impact: either the resolution passes or it does not; whereas there may be importance to understanding what percentage of shareholders shared a voting position and what percentage were opposed.

FIG. 2 is a flow chart of proxy voting by funds in the prior art and shows how information is currently provided about AGM.

The registrar will disseminate the AGM information to the fund managers and voting agents at least one month before the meeting. Investment managers receive this directly if they are the Named Member or via the nominee of the custodian account otherwise (this complication is omitted in the diagram).

At the time of votes being cast, the custodian of the underlying security will confirm how many shares are held by the fund manager. Between the votes being cast, the AGM assets are routinely traded by fund managers. Around 48 hours prior to the AGM, there is a cut off (usually at the end of the trading day) and it is this snapshot in time of the holdings of each of the named members of the listed entity that is used when counting votes. For any fund manager, where the votes received is greater than the shares held, at least some of these votes may be discarded unless significant in number and the differences can be simply reconciled. Similarly, if the fund manager holds more shares than they held at the time of voting then the additional shares are not voted since the registrar does not have instructions on how these shares are to be voted. Fund managers can split their vote. For example, if they are managing the NHS pension plan and a private pension plan, the trustees of the NHS plan may give instructions to vote a particular way which goes against how the fund manager will be voting more generally. For example, the votes cast could be 250,000 votes for, 750,000 against, and 35,000 abstain.

The registrar will have to reconcile the votes received with the register of Named Members at the cut off They may need to confer with the voting agents, CREST and the custodian banks to be able to reconcile any differences. The voting agents' system will have the voting information, including the holding information at the time the votes were cast. This can be an inconsistent record since votes could be cast at any time between the AGM announcement and the cut off. For example, Fund A could cast their vote twenty days before the cut off, and subsequently sell half their shares in the listed entity. Some of the sold shares could be bought by another fund in this time who could cast their votes five days before the cut off. The CREST and the custodian banks' systems will typically have the most granular information about the overall holdings of the fund manager. However, custodian banks can operate pooled accounts and so may not have enough detail to account for a split vote. This represents a barrier to devolving power further to the end investor. The fund manager's system would have the full breakdown of the holdings of separate funds they manage but they outsource the verification of this to the custodian who is a trusted third party. They would also have information about the number of units end investors hold at any point in time which would be essential to devolving voting rights.

### SUMMARY OF THE INVENTION

An object of an embodiment of the present invention is to provide a way to update a transaction made on a distributed ledger, preferably one implemented using blockchain technology. This does not revise transaction data stored on the ledger, but provides for multiple possible states for the stored transaction data, e.g., three possible states for the stored transaction data, an initial state, an update state and a final state.

System and methods of certain embodiments of the present invention utilize a private distributed ledger and a network protocol interface. The private network can operate with desktop or mobile terminals upon successful user authentication. The transaction data from an authenticated user of a terminal are received at the protocol interface via the internet in the form of a cryptographic string signed with the user private key. A notary entity on the private distributed ledger verifies and validates the authenticity of the transaction data and when validated, the result is added to the user's distributed ledger data-structure. All the transactions are atomically timestamped and the data on the distributed ledger is updated in near real time. The result itself is computed/aggregated using the user's homomorphically encrypted data.

Preferably, at moments in time, the transaction hashes on the private network are pushed to and stored on a public distributed ledger or blockchain. This creates a transparent process, maintaining the users' privacy and recording the actions they performed in an encrypted form on the private network.

Updated and/or final transaction data are linked on the distributed ledger to an initial state which maintains its lineage throughout the whole lifecycle of the transaction until the transaction data is marked as final. From this final state forward, no other updates are permitted.

A preferred embodiment of the present invention is a tamper-proof voting system and method which allows one to update the state of a given vote until a voting time cut-off is reached. This embodiment uses asymmetric cryptographic keys, homomorphic or polymorphic encryption and a distributed ledger to guarantee that the identity of the user and the vote cast by the user is kept secret while maintaining full transparency of the vote tally itself. If the user decides to make its vote public, the removal of secrecy can be updated in real time on the blockchain and later votes can use a new set of cryptographic keys to maintain user privacy in the next voting transaction.

In accordance with a preferred embodiment of the present invention, the computer system comprises a first client-server network including a plurality of client devices connected to at least one server for entering transaction data relating to a given transaction. The client devices can be mobile devices, such as smartphones, desktop computers, and laptop computers. A network interface controlled by the at least one server is receptive of transaction data from the client devices for interfacing the transaction data with a distributed ledger network for running self-executing code related to the given transaction and storing transaction data related to the given transaction in accordance with the self-executing code. The self-executing code is preferably a smart contract written in a programming language such as Solidity and the distributed ledger is preferably one that can execute smart contract code such as the Ethereum blockchain, Hyperledger Fabric and others. The client devices preferably at least homomorphically encrypt transaction data for a given transaction. Homomorphic encryption allows mathematical operation on the underlying data to be performed without revealing the underlying data. Mathematical operations such as addition, subtraction, multiplication and division can be used depending upon the type of transaction. The network protocol provides the homomorphically encrypted transaction data to the distributed ledger network wherein the self-executing code performs at least one mathematical operation on the homomorphically encrypted transaction data without the need to access the transaction data in its unencrypted form. The self-executing code defines a time limit for receiving transaction data from a client device for a given transaction, such that the client device can provide initial transaction data and updated transaction data for a given transaction until the end of the time limit. After the end of the time limit, the transaction data is deemed to be in its final state. The distributed ledger stores the initial transaction data and the updated transaction data for a given transaction and the self-executing code for the given transaction performs the at least one mathematical function on the initial transaction data and the updated transaction data.

As noted, the self-executing code is preferably a smart contract. In addition, the network protocol can be expanded to use polymorphic encryption to selectively encrypt transaction data for a given transaction. The transaction data preferably includes a transaction identification and a client device identification. Preferably, the self-executing code receives an identification for a client device initiating a transaction, a description of the transaction, and a time deadline. Preferably, a client device can designate transaction data for a given transaction as “final” prior to the end of the applicable time limit and the self-executing code will not permit any further updated transaction data from that client device for that transaction. In a preferred embodiment, the distributed ledger is storing user's homomorphically encrypted voting position. In a particularly preferred embodiment, the transaction is a vote for a resolution (e.g., shareholder resolution, government legislation, private or public election, or the like) and the self-executing code adds the total votes for the resolution from each client device as the votes are updated.

In accordance with an embodiment of the invention, a method comprises the steps of providing a first client-server network including a plurality of client devices connected to at least one server for entering transaction data relating to a transaction, providing a network interface controlled by the at least one server and receptive of transaction data from client devices with a distributed ledger network for running self-executing code related to the transaction and storing transaction data related to the transaction in accordance with the self-executing code, and client devices at least homomorphically encrypting transaction data for the transaction and wherein the network interface provides the homomorphically encrypted transaction data to the distributed ledger network, wherein the self-executing code performs at least one mathematical operation on the homomorphically encrypted transaction data without the need to access the transaction data in its unencrypted form and wherein the self-executing code defines a time limit for receiving transaction data from a client device for a given transaction such that the client device can provide initial transaction data and updated transaction data for a given transaction until the end of the time limit and wherein the distributed ledger stores the initial transaction data and the updated transaction data for the transaction and wherein the self-executing code for the transaction performs the at least one mathematical function on the initial transaction data and the updated transaction data.

These and other objects and advantages of the present invention will become more apparent from the following detailed description along with the attached drawings.

### BRIEF DESCRIPTION OF THE DRAWINGS

FIG. 1 is a flow chart of proxy voting by individuals in the prior art;

FIG. 2 is a flow chart of proxy voting by funds in the prior art;

FIG. 3 is a block diagram of an improved computer system for carrying out a method according to an embodiment of the present invention;

FIG. 4 is a more detailed block diagram of the system of FIG. 3;

FIG. 5 is a flow chart of a method according to an embodiment of the present invention;

FIG. 6 is a flow chart of proxy voting by individuals according to an embodiment of the present invention; and

FIG. 7 is a flow chart of proxy voting by funds according to an embodiment of the present invention.

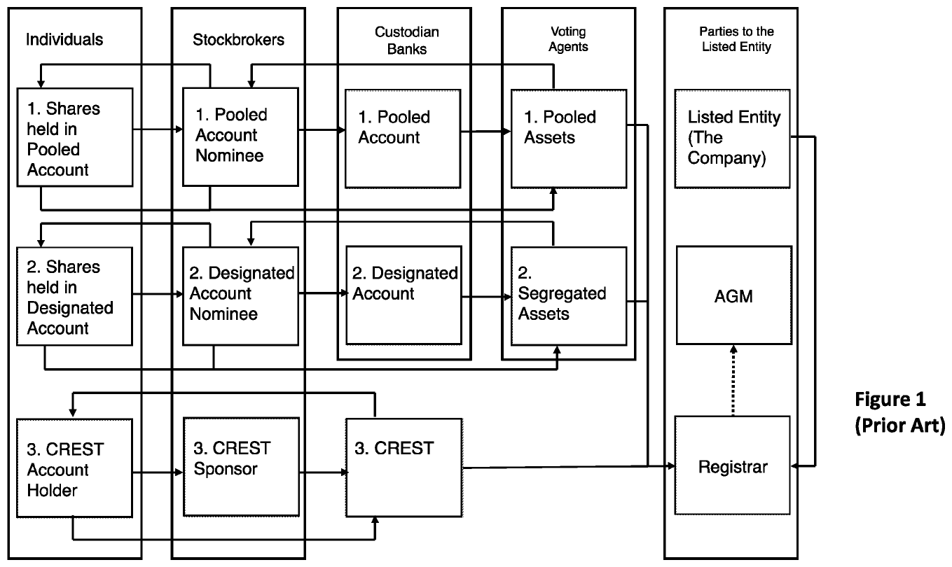

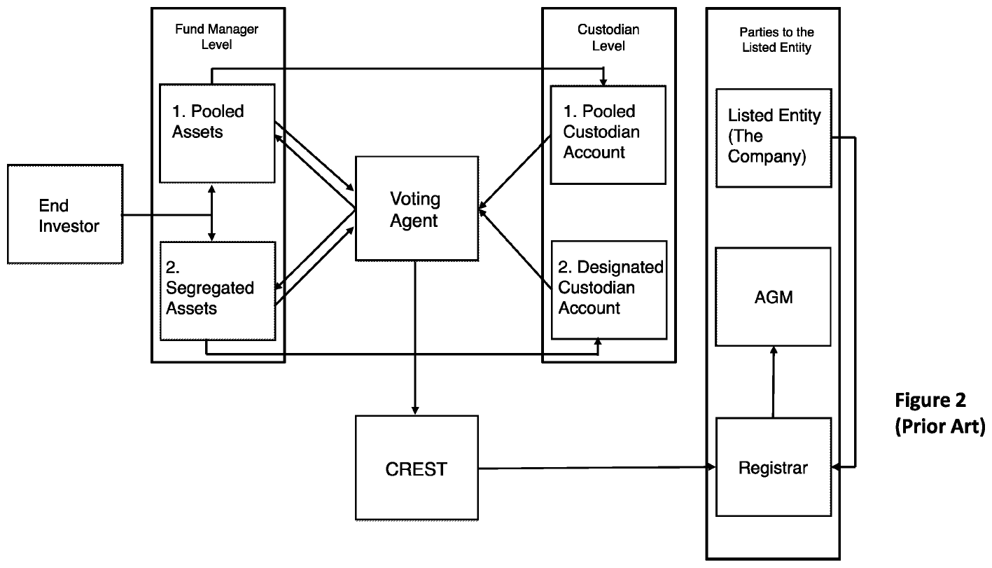

### DETAILED DESCRIPTION OF THE PREFERRED EMBODIMENTS

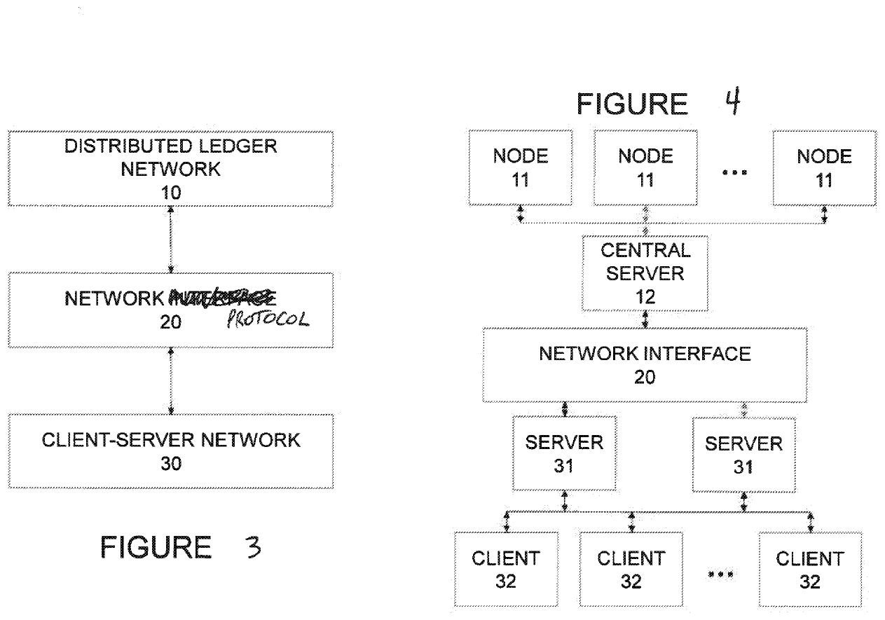

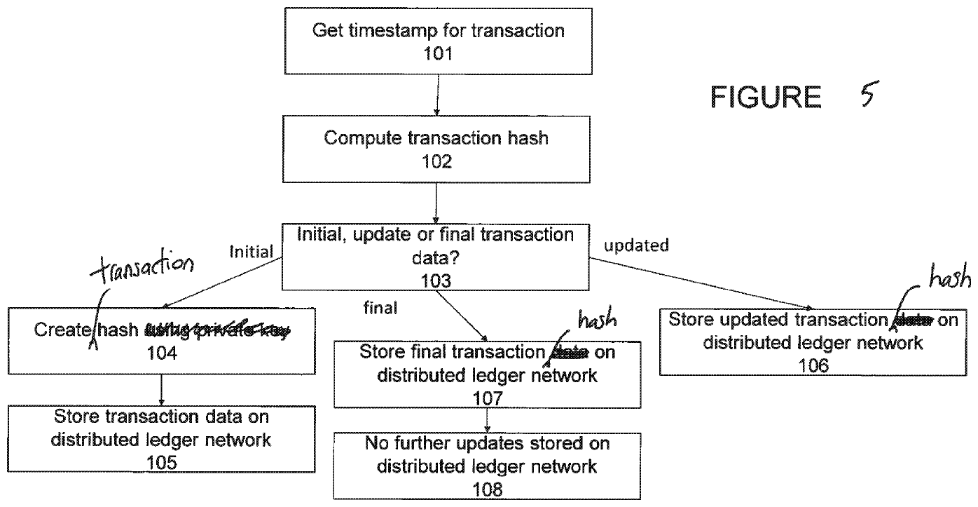

As shown in FIGS. 3 and 4, the client server network 30 in accordance with a preferred embodiment of the present invention sends transaction data to and receives data from a network protocol interface 20 which interfaces network 30 with a distributed ledger network 10 which preferably uses blockchain technology. The client server network is preferably an internet-connected network and the network interface interacts with one or more servers 31 of the network 30. The client devices 32 can be mobile devices, such as tablets or smartphones, or personal computers, such as desktop computers or laptops. For business clients, the computers can be minicomputers or main frame computers with communication capabilities.

The distributed ledger network 10 is preferably a public blockchain network, such as Ethereum or Hyperledger Fabric, and is a network of nodes 11 connected by the Internet with each node having at least a portion of a ledger and wherein certain nodes are capable of running self-executing software, such as smart contracts, that perform operations with data stored on the ledger. Where the distributed ledger is a permissioned ledger, there is preferably a central server (or gateway or protocol) 12 that allows nodes access to only certain data. Optionally, central server 12 may be omitted and nodes 11 connected directly (or indirectly) to network protocol 20.

The network 10 has the advantages of allowing entities to join or leave at will. Clients of the network 30 are able verify the integrity of the transaction hashes of their votes on the public network. The protocol interface separates the network 10 from the network 30 to preserve privacy.

A plurality of clients 32 are able to execute a voting transaction with a self-executing smart contract code. The vote is not marked final until a client designates it as such or the self-executing code determines that the time period is over.

The ledger 10 stores the hashes of transactions (e.g., votes) executed on the private chain 30. The hash of the smart contract controlling the transaction is stored on the distributed ledger 10.

The transaction data resulting from the clients and received by the self-executing software is encrypted with a homomorphic or polymorphic encryption key. The data can be accessed in an aggregated way for multiple users entitled to see the results. It also verifies that the transaction data is not tampered with through the corresponding hash made public on the blockchain. The transaction data can be updated during the lifetime of the transaction or until the data is marked final.

In an exemplary embodiment, the transaction is a corporate resolution to be voted on by a number of entities having access to client devices for transmitting transaction data including the vote of yes, no, or abstain, on the resolution.

The actions submitted to be voted on, such as but not limited to, a corporate resolution are modelled using an OWL-RDF (Web Ontology Language) like language. The data is stored in a form for usage in distributed ledger technology, such as but not limited to, a smart contract.

A standard interlinked data model for data interchange facilitates data merging even if the underlying schemas differ, and it specifically supports the evolution of schemas over time. This aspect is used to accommodate the immutability of the ledger network 10 by using multiple pointers to the cryptographically-signed underlying data structure.

The linking structure is extended by using URLs, such as links to a resolution available on the web or PDF saved and hashed onto the private ledger. Using this model, it allows structured and semi-structured data to be mixed, exposed, and shared across self-executing smart contracts.

The transaction data stored on the network 30 and the operation of the smart contract can be expressed in the form of data definitions. For the smart contract:

```
Ontology {
  Originating URL,
  Import: resolution template URL,
  Resolution type = “proposal” {
    Title: Resolution Title,
    Owner: Resolution owner,
    Final-voting-deadline: timestamp,
    Resolution description: {
      Description: text,
      Overview: text,
      Scope: text
    }
  }
}
```

This allows the nodes 11 to check before any transaction data is stored that the hash of the submitted vote request matches the resolution it was pointed to.

The network 30 records the transaction data made for a specific smart contract by linking its unique hash to the ledger hash this submission generates. The network 30 will export the recorded transaction at the time of creation. Network 30 is preferably using a HSM module. In cryptography, an HMAC (hash-based message authentication code) is a specific type of message authentication code (MAC) involving a cryptographic hash function and a secret cryptographic key. It may be used to simultaneously verify both the data integrity and the authentication of a message, as with any MAC. The cryptographic strength of the HMAC depends upon the cryptographic strength of the underlying hash function, the size of its hash output, and the size and quality of the key.

HMAC uses two passes of hash computation. The secret key is first used to derive two keys—inner and outer. The first pass of the algorithm produces an internal hash derived from the message and the inner key. The second pass produces the final HMAC code derived from the inner hash result and the outer key. Thus, the algorithm provides better immunity against length extension attacks.

The smart contract implementation is in the form of a state machine that allows the following votes:

### Support=>Yay=>2

### Reject=>Nay=>1

### Abstain=>0

The record on network 30 is:

| | |
|---|---|
| << | (#UserId), [0, 1, 2], |
| | HMAC of user private key and resolution ID |
| | encrypt(resolutionID, vote), |
| | #tx on chain, [Initial, Update, Final] >> |
| | The record on the network 10 is: |
| << | #trx hash of network 30>> |

According to an embodiment of the present invention, each client comprises: one or more machines (e.g., PCs, tablets, mobile phones) connected to a network, and each machine comprises: a processor, a non-volatile memory computer readable memory and a network interface. Each user is assigned a homomorphic or polymorphic cryptographic key. The system may use any standard to generate the keys, however, it is a requirement that the voter key pair is generated with the types above.

The private key is used to apply a digital signature to the user vote. The public key is used to uniquely identify the user casting the vote.

FIG. 5 is a flow chart of a method in accordance with an embodiment of the present invention. A client device 32 gets a timestamp for a transaction such as a vote in step 101. Thereafter, the client device computes a hash of the transaction using a hash function such as SHA256. The transaction data that is to be sent to network 10 then takes one of three paths, depending upon whether the data is initial transaction data, updated transaction data, or final transaction data. This is determined in step 103. For the application of a vote, the user may set a default value for a vote so that the initial data is always the default value or abstain, yes or no until it is updated or made final due to the expiration of the time period for the vote.

For initial data, the client device signs the transaction with its private key in step 104 and the data is homomorphically encrypted. The smart contract links the data to the user and performs a vote tally using the encrypted data to provide a current vote tally without revealing who voted and what the vote was. The hash of this transaction is stored on network 10 in step 105. For updated data, the new transaction hash is stored on the network 10 in step 106. The smart contract updates the vote tally in accordance with the updated vote. When the data is made final, the last transaction hash is stored on the network 10 and the smart contract on the private ledger 30 updates the vote tally and prevents any further update to the data.

The voting application is preferably used to improve corporate accountability and investments. In this ecosystem, the power of corporations is commonly understood to be held in check by the rights and responsibilities of shareholders.

However, there are three major problems with this system, resulting in a situation where the majority of shareholders are disenfranchised from having a say, and where those powerful few that do have a say are hidden from scrutiny.

Investors that have significant influence over the direction and decisions of companies should be identifiable but are currently hidden in the complex web of the investment ecosystem. Conversely, individuals do not have ready access to information about the assets that lie behind their savings and investments.

In most cases, only first level investors are able to take part in the annual general meeting (AGM) voting process. As a result, most investors, e.g., those invested in collective funds such as pensions, are disenfranchised from their ability to influence corporate power.

Less than 30% of shareholders voted their shares in 2014 according to voting administrator Broadridge. Investors are distanced from the AGM process by the multitude of companies that sit in the investment ecosystem, and there are few instances where shareholders can act in concert to propose corporate resolutions.

With the rise of ESG investment themes, focus on sustainability and increased shareholder activism across the world since 2008, we strongly believe this is an excellent time to build a solution that allows shareholders to engage with companies and jointly script their future. Recent legislative moves, especially the European Shareholders Rights Directive (SRD II) set out to strengthen the position of shareholders and place responsibilities on intermediaries to facilitate the exercise of shareholder rights. This is expected to be implemented in Q2 2019.

One object is to transform the investment ecosystem, in order to bring transparency and democratic participation for all beneficial owners of investments and to enable meaningful engagement in the voting process. The invention will do this through an online platform that will provide accessible data on shareholdings, voting patterns, and also offer the ability for all beneficial owners to vote the shares they own, as well as shape new external resolutions.

There are three principles that would underpin an effective system of corporate accountability that will utilize the present invention:

1) Transparency of Share Ownership.

Those that have significant influence should be easily identifiable to all. Conversely any individual should have ready access to information about the assets that lie behind their savings and investments.

2) Corporate Democracy.

First Level Investors shouldn't disenfranchise those upstream in the investment chain from their ability to influence corporate power and ultimately Beneficial Owners should be able to engage in this process.

3) Meaningful Investor Engagement.

Effective Corporate Accountability requires those voting to have timely access to the pertinent information surrounding the AGM and anyone who has engaged in the process has the right to know the outcome of their actions. Further, the volume of engagement is important, the total votes cast should represent a healthy quorum for checks on corporations to be effective.

In the corporate accountability ecosystem, there are many intermediaries that are involved with the chain of ownership, communication and proxy voting.

The Key Stakeholder Groups.

General Public: Citizens as stakeholders who are impacted by the actions of large corporations whether or not they hold savings or investments.

Beneficial Investors: Individuals who hold investments, either directly in listed equity or via intermediaries such as a Fund Manager of a private pension. These are sometimes referred to elsewhere as End Level Investors because there are no investors upstream of them.

Investors: “Investors” is only used when we are being deliberately broad. This could be an individual investing their own money or an investment professional anywhere along the investment chain acting on behalf of those further upstream in the chain. They could be investing in units of a Fund or directly in equities.

First Level Investors: This is any individual or entity that invests in individual stocks. An individual may invest in stocks themselves and be both the First Level Investor and Beneficial Investor; in the investment industry the First Level Investor might be a Fund.

Outsiders: Stakeholders that are outside the investment ecosystem but who conduct research or seek to influence the investors of the Listed Entity. This may include shareholder action groups, journalists, and private sector and investment sector activist organizations.

Financial institutions: Institutions that manage Funds, for example Insurance companies; Pension Funds, etc.

Custodian Banks: An institution that is responsible for the safekeeping and servicing of assets belonging to another. Custodians will often handle administrative arrangements such as collecting coupons and dividends. In the investment industry, assets that a Fund wishes to buy and receive the economic benefit from are held by a Custodian.

Registrars: A company which manages the register of shareholders on behalf of a listed entity, responsible for day-to-day communication with shareholders over matters relating to the management of their shareholdings—change of address, dividend payment, transmission of shares, etc.—and also manages the general meeting voting process on behalf of a Listed Entity.

Listed Entity: A publicly listed company.

Proxy Voting: Proxy voting is the business of electing the Chair of the AGM to vote by proxy on your behalf during the AGM, thus exercising your shareholder voting rights without having to attend the AGM in person. As most votes are cast in this way (87% of FTSE 100 AGM Votes in 2017) it's important to examine the role of the various stakeholders in this process. In principal the same process can (and has) been applied to casting votes during the AGM.

We will first map how the process of Proxy voting works for individuals before we outline how this same process works for Institutional Investors.

Proxy Voting for Individuals

Typically, shares bought through a stockbroker (online platform or otherwise) are held on account by a Custodian Bank employed by the Stockbroker and, in most instances, these assets are pooled with those of other clients of the same broker.

For larger portfolios, an individual may have a designated account with the Custodian; this is where the Custodian Account name might be “Stockbroker X, Client 123”; in which case these assets are segregated rather than pooled with those of other clients of the same broker.

Alternatively, the individual may be a CREST account holder. This is typically for larger portfolios and, as we will explore in a subsequent section, this is the most common ownership structure for Institutional Investors.

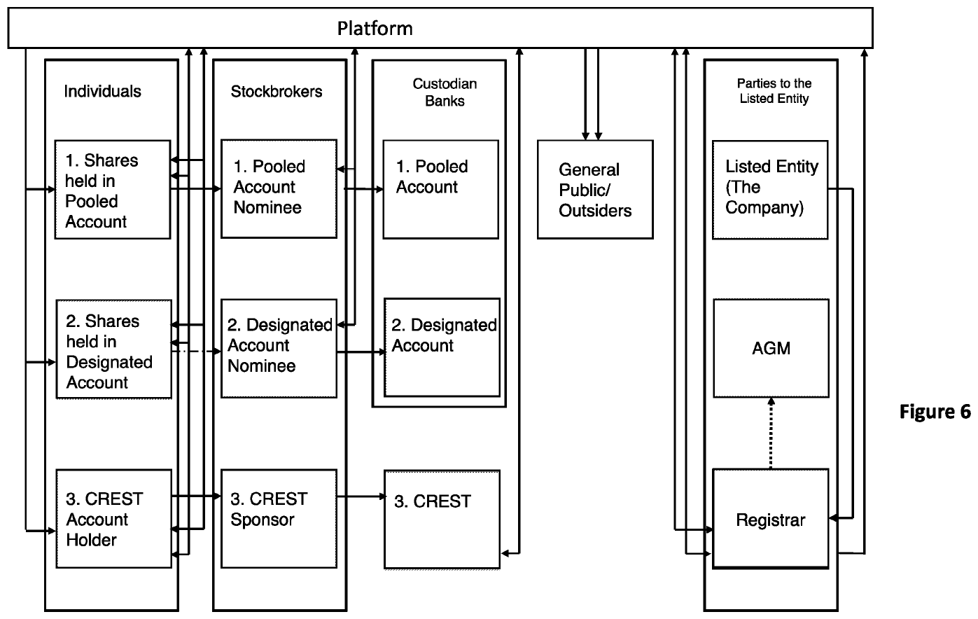

FIG. 6 illustrates an embodiment of the present invention. Live holding information is distributed to each of the individuals, the pooled account nominee, the designated account nominee, the registrar, and optionally, the vote aggregator (e.g., CREST). The resolutions are provided to each of the individuals. Live voting information is exchanged between the individuals and the platform. Aggregated vote information is transmitted by the platform to the registrar. The registrar sends the final voting report (e.g., AGM voting report) to the AGM.

Information about the AGM is collected from the Listed Entity via the Registrar and disseminated to investors via the platform of an embodiment of the present invention. AGM information on the platform can now reach anyone in the investment chain, as well as the general public and outsiders, and all of this can be achieved in a timely manner. This is central to the third principle of Effective Corporate Accountability: meaningful engagement requires all stakeholders to have timely access to pertinent information surrounding the AGM.

Information about holdings is collected from the Registrar, from CREST and from stockbrokers. Detailed information is served to investors (in relation to their own holdings) and used to inform the counting of votes cast by proxy ahead of the AGM. Aggregated information is served to anyone in the investment chain, outsiders and the general public. This is central to the first principle of Corporate Accountability: Transparency of Share Ownership.

Votes can be cast on the system of the present invention; votes cast can easily be reconciled with live holding information and those voting can receive vote confirmation. This is central to the third principle of Effective Corporate Accountability which states that anyone who has engaged in the process has the right to know the outcome of their actions. Increased integrity in the system will lead to greater trust and greater engagement which is also important to the third principal which states that: the total votes cast should represent a healthy quorum for checks on corporations to be effective.

Individuals may also have a stake in a listed entity through a collective investment vehicle such a mutual fund or pension. In such instances, we can think of the individual as the end-level investor or beneficial owner while a fund manager might be a first-level investor in a listed entity, investing on behalf of the fund which will have many, if not hundreds of thousands of, beneficial owners.

The fund assets are preferably held by a custodian bank and the shares are owned through CREST. The custodian bank will operate accounts relating to the assets and, depending on the size of the fund, the assets may be pooled together with other funds or may be held in a designated account.

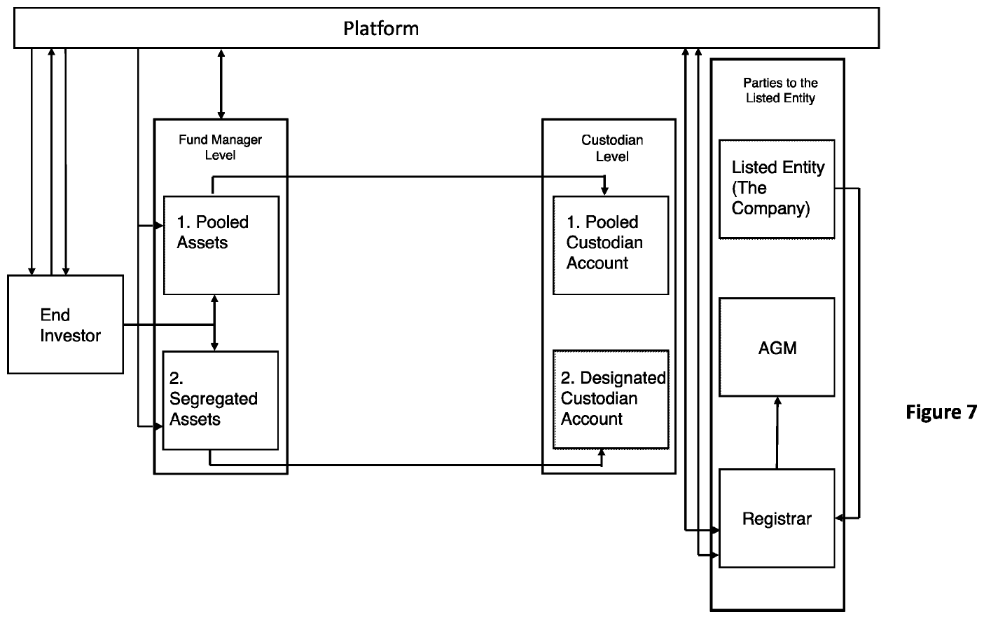

FIG. 7 illustrates how information is disseminated in accordance with an embodiment of the present invention. Live voting information is provided by the end investor to the platform. Live holding information is distributed to the end investor, fund manager level, and registrar. The resolutions are provided to each of the individuals. Live voting information is exchanged between the individuals and the platform. Aggregated vote information is transmitted by the platform to the general public/outsiders and the registrar. The registrar sends the final voting report (e.g., AGM voting report) to the AGM.

Information about the AGM is collected from the listed entity via the registrar and disseminated to all investors in the chain via the platform according to an embodiment of the present invention. This is central to the third principle of Effective Corporate Accountability: meaningful engagement requires all stakeholders to have timely access to pertinent information surrounding the AGM.

Information about holdings is collected from the registrar and from the fund manager. Detailed information is served to fund managers and end investors (in relation to their own holdings) and used to inform the counting of votes cast by proxy ahead of the AGM. Aggregated information is served to anyone in the investment chain, outsiders and the general public. This is central to the first principle of Corporate Accountability: Transparency of Share Ownership.

End investors can cast vote on the system of the present invention; votes cast can easily be reconciled with live holding information and those voting can receive vote confirmation. This is central to the second principle of Effective Corporate Democracy which states that: first level investors should not disenfranchise those upstream in the investment chain from their ability to influence corporate power and ultimately beneficial owners should be able to engage in this process.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures and configurations, but the desired features can be implemented using a variety of alternative architectures and configurations. Indeed, it will be apparent to one of skill in the art how alternative functional, logical, or physical partitioning and configurations can be implemented to implement the desired features of the present disclosure. For example, while a single server and a single database are illustrated, the server functions can be distributed over a number of servers, and the database can exist in a number of locations. The functionality of the phones also is for the purpose of example and other implementations are within the scope of this invention. Additionally, with regard to flow diagrams, operational descriptions, and method claims, the order in which the steps are presented herein shall not mandate that the steps of the various embodiments be implemented in the order presented, unless the context dictates otherwise.

Although the disclosure is described above in terms of various example embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the disclosure, whether or not such embodiments are described, and whether or not such features are presented as being a part of a described embodiment. Thus, the breadth and scope of the present disclosure should not be limited by any of the above-described example embodiments, and it will be understood by those skilled in the art that various changes and modifications to the previous descriptions may be made within the scope of the claims.

What is claimed is:

1. A computer system comprising:
a first client-server network including a plurality of client devices connected to at least one server for entering transaction data relating to a given transaction;
a network interface controlled by the at least one server and receptive of transaction data from the client devices for interfacing the transaction data with a distributed ledger network for running self-executing code related to the given transaction and storing transaction data related to the given transaction in accordance with the self-executing code;
wherein client devices at least homomorphically encrypt transaction data for a given transaction;
wherein the network interface provides the homomorphically encrypted transaction data to the distributed ledger network wherein the self-executing code performs at least one mathematical operation on the homomorphically encrypted transaction data without the need to access the transaction data in its unencrypted form;
wherein the self-executing code defines a time limit for receiving transaction data from a client device for a given transaction such that the client device can provide initial transaction data and updated transaction data for a given transaction until the end of the time limit;
wherein the distributed ledger stores the initial transaction data and the updated transaction data for a given transaction; and
wherein the self-executing code for the given transaction performs the at least one mathematical function on the initial transaction data and the updated transaction data.

2. The computer system according to claim 1, wherein the homomorphic encryption utilizes a private key and a public key and wherein the distributed ledger validates the authenticity of the transaction data from a given client device using the public key of the client device.

3. The computer system according to claim 1, wherein the self-executing code is a smart contract.

4. The computer system according to claim 1,
wherein the at least homomorphic encryption comprises polymorphic encryption and
wherein the server controls the network interface to selectively homomorphically encrypt transaction data for a given transaction.

5. The computer system according to claim 1, wherein the transaction data includes a transaction identification.

6. The computer system according to claim 1, wherein the transaction data includes a client device identification.

7. The computer system according to claim 1,
wherein a client device can designate transaction data for a given transaction as final prior to the end of the time limit and
wherein the self-executing code will not permit any further updated transaction data from that client device for the given transaction.

8. The computer system according to claim 1, wherein the self-executing code receives an identification of a client device initiating a transaction, a description of the transaction, and a time deadline.

9. The computer system according to claim 1, wherein a client device stores an at least homomorphically encrypted client device identification, a hash of a user private key and the identification of the given transaction, an at least homomorphically encrypted identification of the given transaction and whether the transaction data is initial, updated or final.

10. The computer system according to claim 1, wherein the distributed ledger network stores a hash of the transaction data for a given transaction, an at least homomorphically encrypted client device identification a public key for a client device and whether data is initial, updated or final.

11. The computer system according to claim 1, wherein the given transaction is a vote for a resolution and wherein the self-executing code adds the total votes for the resolution from each client device as the votes are updated.

12. A method comprising the steps of:
providing a first client-server network including a plurality of client devices connected to at least one server for entering transaction data relating to a given transaction;
providing a network interface controlled by the at least one server and receptive of transaction data from the client devices for interfacing the transaction data with a distributed ledger network for running self-executing code related to the given transaction and storing transaction data related to the given transaction in accordance with the self-executing code;
client devices at least homomorphically encrypting transaction data for a given transaction;
wherein the network interface provides the homomorphically encrypted transaction data to the distributed ledger network;
wherein the self-executing code performs at least one mathematical operation on the homomorphically encrypted transaction data without the need to access the transaction data in its unencrypted form;
wherein the self-executing code defines a time limit for receiving transaction data from a client device for a given transaction such that the client device can provide initial transaction data and updated transaction data for a given transaction until the end of the time limit;
wherein the distributed ledger stores the initial transaction data and the updated transaction data for a given transaction; and
wherein the self-executing code for the given transaction performs the at least one mathematical function on the initial transaction data and the updated transaction data.

13. A system comprising:
a plurality of client devices for entering a transaction data relating to a transaction and homomorphically encrypting said transaction data; and
at least one server, connected to said plurality of client devices, configured to receive transaction data from the client devices, to create a hash of the transaction data, and store said hash in a blockchain;
wherein at least one client device provides an updated transaction data with a timestamp to the at least one server;
wherein the at least one server performs at least one mathematical operation on the homomorphically encrypted transaction data without the need to access the transaction data in its unencrypted form; and
wherein the server compares said timestamp to a time limit for receiving transaction data, disregards said updated transaction data corresponding to a timestamp after said time limit, and creates a second hash of the updated transaction data and stores said second hash in a blockchain for updated transaction data corresponding to a timestamp before said time limit.
